(19) United States
(12) Patent Application Publication
(10) Pub. No.: US 2024/0034377 A1
(43) Pub. Date: Feb. 1, 2024

(54) HAND TRUCK ASSEMBLY AND RELATED DEVICES AND METHODS

(71) Applicant: Kevin Barry, Beverly, MA (US)

(72) Inventor: Kevin Barry, Beverly, MA (US)

(21) Appl. No.: 18/226,910

(22) Filed: Jul. 27, 2023

Related U.S. Application Data
(60) Provisional application No. 63/393,561, filed on Jul. 29, 2022.

(51) Int. Cl. B62B 1/14; B62B 1/12

(52) U.S. Cl. CPC B62B 1/14; B62B 1/125; B62B 2206/06; B62B 2205/30; B62B 2301/08

(57) ABSTRACT

An expandable hand truck configured to transport one or more containers or other type of load includes a frame having a base platform and a back fixedly attached to the base platform and at least two wheels fixedly mounted on the frame. The base platform extends in a substantially horizontal direction and the back extends in a substantially vertical direction when the expandable hand truck is in an upright position. The frame also includes one or more first attachment features on a first side that permit a first removable gullwing to be attached to and removed from the frame. The frame further includes one or more second attachment features on a second side that permit a second removable gullwing to be attached to and removed from the frame. An expanded hand truck is provided when the first gullwing and the second gullwing are coupled to the frame.

### CROSS-REFERENCE TO RELATED APPLICATIONS

This application claims the benefit of U.S. Provisional Patent Application No. 63/393,561 filed Jul. 29, 2022, the entire contents of which are incorporated by reference herein.

### FIELD

The subject disclosure relates to hand truck devices, and more particularly, to an expandable hand truck that can be releasably coupled to one or more gullwings.

### BACKGROUND

Hand trucks are non-motorized devices that are generally L-shaped with a front nose plate, an upper portion, and two wheels. The nose plate of the hand truck can be inserted beneath a load and the hand truck can then be tilted back on its wheels to roll the load while the upper portion supports the load during transport. Conventional hand trucks have fixed dimensions and therefore are ill-suited for transporting a variety of loads.

### SUMMARY

The present disclosure provides a versatile hand truck capable of expanding to accommodate multiple loads (e.g., containers) of varying sizes. In so doing, the disclosed expandable hand truck addresses technical problems associated with existing various types of devices. The disclosed expandable hand trucks are configured to transport any desired type of container or load, including waste or recycling containers or other materials.

Conventional waste or recycling containers sometimes include two integral wheels that can be used to support the container as it is rolled to a destination. However, these wheeled containers are rudimentary in structure and do not allow for ease of use or efficiency for travel over long distances. Also, since each container has its own set of wheels, transporting more than one wheeled container at once is unfeasible. The presently disclosed expandable hand trucks and related devices overcome these shortcomings of conventional waste and recycling containers.

Illustrative expandable hand truck devices as well as expandable hand truck assemblies and related methods are described. The disclosed devices and assemblies have adjustable dimensions to enable versatile load-carrying capabilities. The disclosed expandable hand truck devices include a main unit having a frame with a base platform and a back fixedly attached to the base platform. The base platform extends in a substantially horizontal direction and the back extends in a substantially vertical direction when the expandable hand truck is in an upright position. In some implementations, the base platform may be hingedly connected to the back, allowing the main unit to be folded into a compact configuration. The expandable hand truck includes at least two wheels fixedly mounted on the frame that are positioned to engage with the ground. The frame also includes one or more first attachment features on a first side that permit a first removable gullwing to be attached to and removed from the frame. The frame further includes one or more second attachment features on a second side that permit a second removable gullwing to be attached to and removed from the frame. In some embodiments, the one or more first attachment features and the one or more second attachment features are slots that engage with mating features on the first gullwing and/or the second gullwing. However, in other embodiments, the one or more first attachment features and the one or more second attachment features are keys and/or keyholes that engage with mating features on the first gullwing and/or the second gullwing. In select embodiments, the one or more first attachment features and the one or more second attachment features are hinges that permit the first removable gullwing and the second removable gullwing to pivot with respect to the frame when attached to the frame. In some such embodiments, a first hinge member is attached to a first side of the back and a second hinge member is attached to an opposing second side of the back, the first hinge member is configured to receive a mating hinge feature of the first removable gullwing, and the second hinge member is configured to receive a mating hinge feature of the second removable gullwing.

When the expandable hand truck is in an upright position, the base platform rests on a ground surface and the base platform lifts off the ground surface when the expandable hand truck is rotated onto the at least two wheels. In some embodiments, a handle may be positioned on a top portion of the back. The handle may be adjustable in a vertical and/or a horizontal direction. The expandable hand truck may also include a footplate extending from a bottom rear side of the frame. In these and other embodiments, a detachable tether may be included to retain one or more containers on the expandable hand truck. The detachable tether may be extendable from the first side of the back to the second side of the back and may be implemented with a corded or a non-corded elastic material. In some embodiments, D-rings for securing the tether may be positioned on the first side of the back and the second side of the back and/or on the top of the back and the bottom of the back.

In another aspect, an expandable hand truck assembly is provided. The expandable hand truck assembly includes a main unit, a first gullwing, and a second gullwing. The first and second gullwings may or may not be attached to the main unit. The main unit has a frame with a base platform and a back fixedly attached to the base platform. The base platform extends in a substantially horizontal direction and the back extends in a substantially vertical direction when the main unit is in an upright position. At least two wheels are fixedly mounted on the frame and positioned to engage with the ground. The back includes a first side and an opposing second side. One or more first attachment features are mounted on the first side of the back and one or more second attachment features are mounted on the second side of the back. The first gullwing is removably attachable to (or attached to) the main unit and includes a first upper support affixed to a first lower support. The first attachment features of the main unit are couplable to the first upper support. The second gullwing is removably attachable to (or attached to) the main unit and includes a second upper support affixed to a second lower support. The one or more second attachment features of the main unit are couplable to the second upper support. In select embodiments, a first side of the base platform of the main unit is removably attachable to (or attached to) the first lower support and a second side of the base platform of the main unit is removably attachable to (or attached to) the second side of the second lower support.

In some implementations, the one or more first attachment features and the one or more second attachment features are selected from the group consisting of: slotted channels, spring-loaded keys, and hinges. In select embodiments, the expandable hand truck assembly also includes one or more fasteners configured to rigidly secure the first lower support of the first gullwing and the second lower support of the second gullwing to the base platform of the main unit. In alternative embodiments, when attached to the main unit, the first gullwing and the second gullwing can each be pivoted to transition between a closed position and an open position. In the first gullwing, the first upper support may be substantially perpendicular to the first lower support and, in the second gullwing, the second upper support may be substantially perpendicular to the second lower support. When the first gullwing and the second gullwing are each attached to the main unit, an expanded hand truck is formed.

In another aspect, a method of using the expandable hand truck assembly described herein is provided. The method includes attaching the first gullwing to the main unit by coupling the one or more first attachment features to the one or more first attachment members and attaching the second gullwing to the main unit by coupling the one or more second attachment features to the one or more second attachment members to form an expanded hand truck. The method may also optionally include securing the base platform of the main unit to the first lower support of the first gullwing and securing the base platform of the main unit to the second lower support of the second gullwing. In alternative embodiments, the method may also include pivoting the first gullwing into an open position and pivoting the second gullwing into an open position. In some embodiments, the method may also include loading one or more containers onto the base platform, the first lower support, and/or the second lower support of the expanded hand truck, rotating the expanded hand truck onto the at least two wheels and moving the one or more containers.

In yet another aspect, an expanded hand truck is provided having a main unit, a first gullwing coupled to the main unit, and a second gullwing coupled to the main unit. The main unit includes a frame having a base platform and a back fixedly attached to the base platform. The base platform extends in a substantially horizontal direction and the back extends in a substantially vertical direction when the expanded hand truck is in an upright position. The main unit includes at least two wheels fixedly mounted on the frame and positioned to engage with the ground, one or more first attachment features on a first side of the back, and one or more second attachment features on an opposing second side of the back. The first gullwing includes a first upper support affixed to a first lower support. There are one or more first attachment members mounted on the first upper support and coupled to the one or more first attachment features. The second gullwing includes a second upper support affixed to a second lower support. There are one or more second attachment members mounted on the second upper support and coupled to the one or more second attachment features.

As stated above, the disclosed hand trucks are versatile and capable of expanding (and then contracting) to accommodate multiple loads (e.g., containers) of varying sizes, with a set of two or more wheels mounted on the main unit. The disclosed expandable hand trucks and hand truck assemblies may provide numerous additional advantages over known devices. For example, the disclosed expandable hand trucks are lightweight and easy to maneuver. The expandable hand trucks may have an aluminum or steel frame that is light yet sturdy. In some embodiments, the frame may have a center handle on the back to provide good leverage and control for the user. The frame may also include a foot plate on a back rear portion to allow the user to easily tip the hand truck onto its wheels for a quick initial start. The hand truck may include relatively large wheels (and/or smaller breaker wheels) as compared to the wheels traditionally used for wheeled trash or recycling receptacles to allow the hand truck to easily traverse long distances and/or uneven terrain. Additionally, the dimensions of the disclosed expandable hand trucks can quicky be changed by adding or removing one or more gullwings to appropriately accommodate the type of load to be transported.

### BRIEF DESCRIPTION OF THE DRAWINGS

So that those having ordinary skill in the art to which the disclosed devices, systems, and methods pertain will more readily understand how to make and use the same, reference may be had to the following drawings.

FIG. 1 is a perspective view of an expandable hand truck assembly configured in accordance with embodiments of the subject technology;

FIG. 2 is a perspective view of an expandable hand truck configured in accordance with embodiments of the subject technology;

FIG. 3A is perspective view of an expanded hand truck configured in accordance with embodiments of the subject technology;

FIG. 3B is a right side view of the expanded hand truck shown in FIG. 3A;

FIG. 3C is a front view of the expanded hand truck shown in FIG. 3A;

FIG. 3D is a bottom view of the expanded hand truck shown in FIG. 3A;

FIG. 4A is perspective view of an embodiment of a handle for the disclosed expandable hand trucks;

FIG. 4B is a perspective view of an alternative handle configuration for the disclosed expandable hand trucks;

FIG. 5 is a perspective view of an attachment mechanism for a tether that may be used in connection with the disclosed expanded hand trucks;

FIG. 6 shows a perspective view of an expanded hand truck configured in accordance with some embodiments of the subject disclosure;

FIG. 7 shows a plan view of an expanded hand truck assembly configured in accordance with some embodiments of the subject disclosure;

FIG. 8A shows a main unit of an expandable hand truck with both a wheel and a breaker wheel;

FIG. 8B shows a side close-up view of the wheel and breaker wheel shown in FIG. 8A;

FIG. 8C shows a perspective view of the wheel and breaker wheel shown in FIG. 8A;

FIG. 8D shows a rear view of the wheel and breaker wheel shown in FIG. 8A;

FIG. 9 shows an expanded hand truck configured in accordance with some embodiments of the subject disclosure;

FIGS. 10A and 10B show an embodiment of a first attachment feature and mating feature for attaching one or both gullwings to the main unit;

FIGS. 11A and 11B show an embodiment of a spring-loaded key for attaching one or more gullwings to the main unit;

FIG. 12 shows a flow diagram of a process for assembling and using an expandable hand truck assembly as disclosed herein; and

FIG. 13 shows a flow diagram of a process for assembling and using an expandable hand truck assembly having pivotable gullwings, in accordance with some embodiments of the present disclosure.

### DETAILED DESCRIPTION

As will be appreciated upon consideration of the subject disclosure, the present technology provides expandable hand truck devices and expandable hand truck assemblies with easily adjustable dimensions to accommodate loads of differing sizes. The advantages, and other features of the systems and methods disclosed herein, will become more readily apparent to those having ordinary skill in the art from the following detailed description of certain embodiments taken in conjunction with the drawings which set forth representative embodiments of the present invention. Like reference numerals are used herein to denote like parts. Further, words denoting orientation such as “upper”, “lower”, “distal”, and “proximate” are merely used to help describe the location of components with respect to one another. For example, an “upper” surface of a part is merely meant to describe a surface that is separate from the “lower” surface of that same part. No words denoting orientation are used to describe an absolute orientation (i.e., where an “upper” part must always at a higher elevation).

The subject technology overcomes many of the prior art problems associated with previous hand truck devices by providing a versatile hand truck that can be easily expanded to accommodate larger loads (e.g., waste and/or recycling containers) and returned to smaller dimensions when desired. Conventional hand trucks have fixed dimensions and are not conducive to transporting multiple waste or recycling loads. Although some waste or recycling containers are outfitted with wheels, these wheel arrangements do not allow for easy transport of the containers over long distances or over uneven terrain. The expandable hand truck assemblies provided by the subject disclosure enable a wide range of possible hand truck configurations and dimensions that can be easily tailored to accommodate variable load types and sizes.

In some embodiments, the presently disclosed hand trucks may be configured to transport one or multiple waste or recycling containers. Although terms such as “waste,” “trash,” or “recycling” are used herein, these terms refer to any type of load, including, for example, residential waste products or recycling, municipal waste or recycling, and construction debris. In some embodiments, the disclosed expandable hand trucks may be used to transport containers filled with waste and/or recycling materials. In other embodiments, the disclosed expandable hand trucks may be used to transport loose materials, such as filled trash or recycling bags (without a rigid container), broken-down corrugated boxes, and/or small assembled boxes. However, in other embodiments, the disclosed expandable hand trucks may be used to transport other items, such as fragile and/or heavy goods. In some embodiments, the disclosed expandable hand trucks may be outfitted with wheels designed for transport over sand or other specialized terrain. Numerous possibilities are possible and contemplated herein.

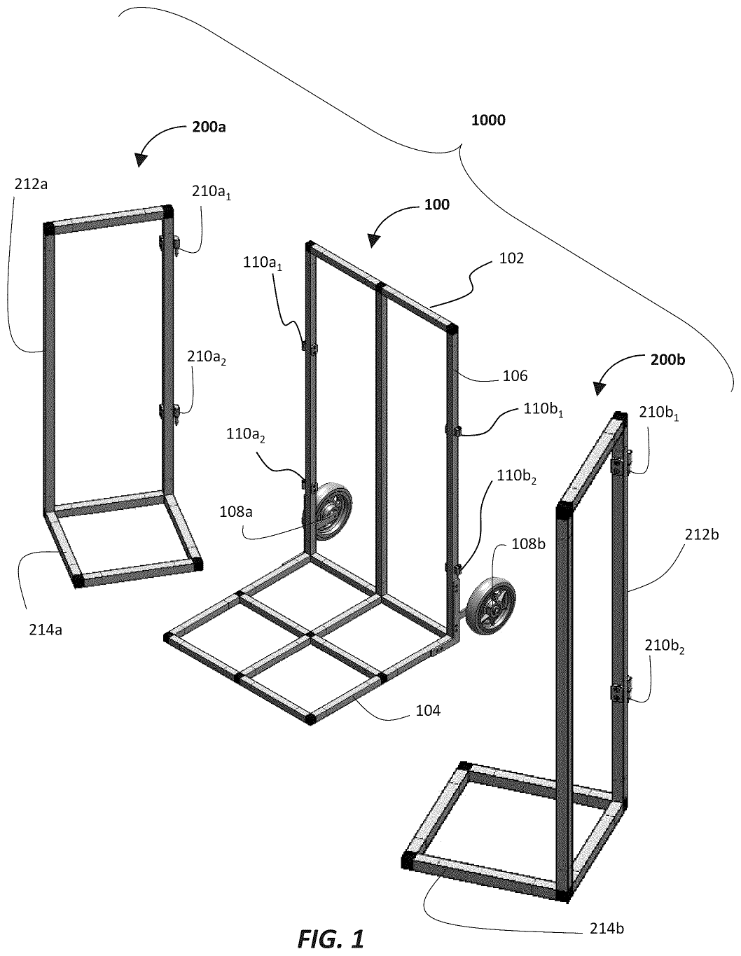

FIG. 1 shows a perspective illustration of a particular expandable hand truck assembly 1000. As shown in FIG. 1, the expandable hand truck assembly 1000 includes a main unit 100, a first gullwing 200a, and a second gullwing 200b. The first gullwing 200a and the second gullwing 200b are each removably attachable to the main unit 100. The hand truck assembly 1000 thus includes all embodiments in which the main unit 100 is attached to the first gullwing 200a and/or the second gullwing 200b or separate from the first gulling 200a and the second gullwing 200b. As used herein, the term “gullwing” refers to a structure that can be easily and quickly removed from the main unit 100. The “gullwings” described herein may or may not be wing-shaped. Additionally, the “gullwings” may or may not be pivotable (like wings) when mounted to the main unit 100.

The main unit 100 includes a frame 102 having a base platform 104 and a back 106 fixedly attached to the base platform 104. The base platform 104 and the back 106 may be integrally formed, welded together, joined with a fastener, or otherwise fixedly attached. In select embodiments, the base platform 104 may be hingedly connected to the back 106 so that, when not in use, the base platform 104 can be folded up vertically against back 106. As shown in FIG. 1, when the main unit 100 is in an upright (and open) position, the base platform 104 extends in a substantially horizontal direction and the back 106 extends in a substantially vertical direction.

Any lightweight yet rigid material can be used to form the frame 102. For example, in some embodiments, the frame 102 may be formed of extruded aluminum and/or steel. In select embodiments 1″ by 1″ extruded aluminum may be used to form the frame 102. In other embodiments, however, the frame 102 may be constructed from another material, such as carbon fiber, wood, steel, and/or composite.

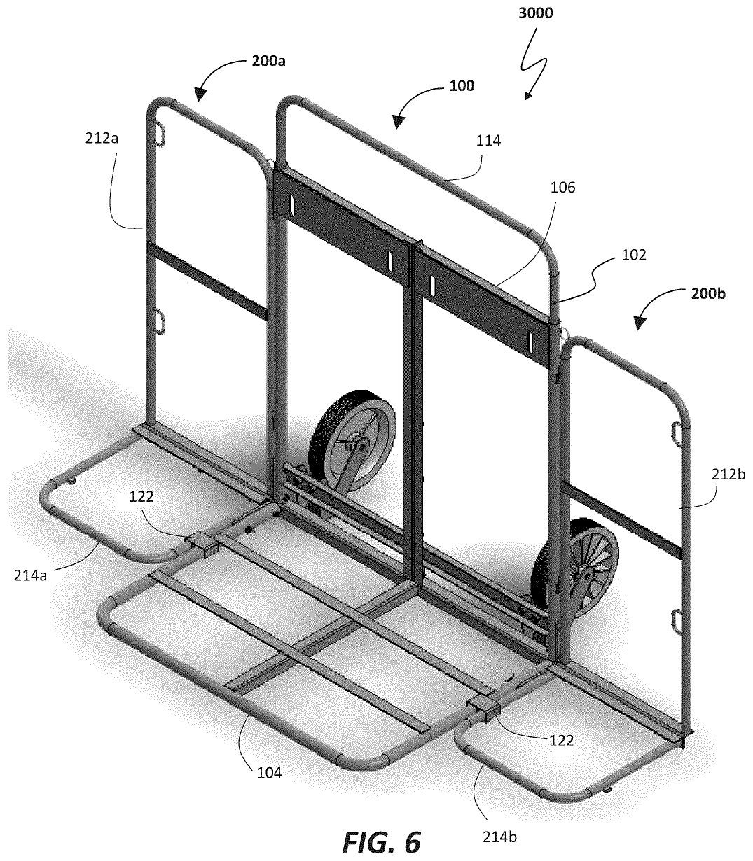

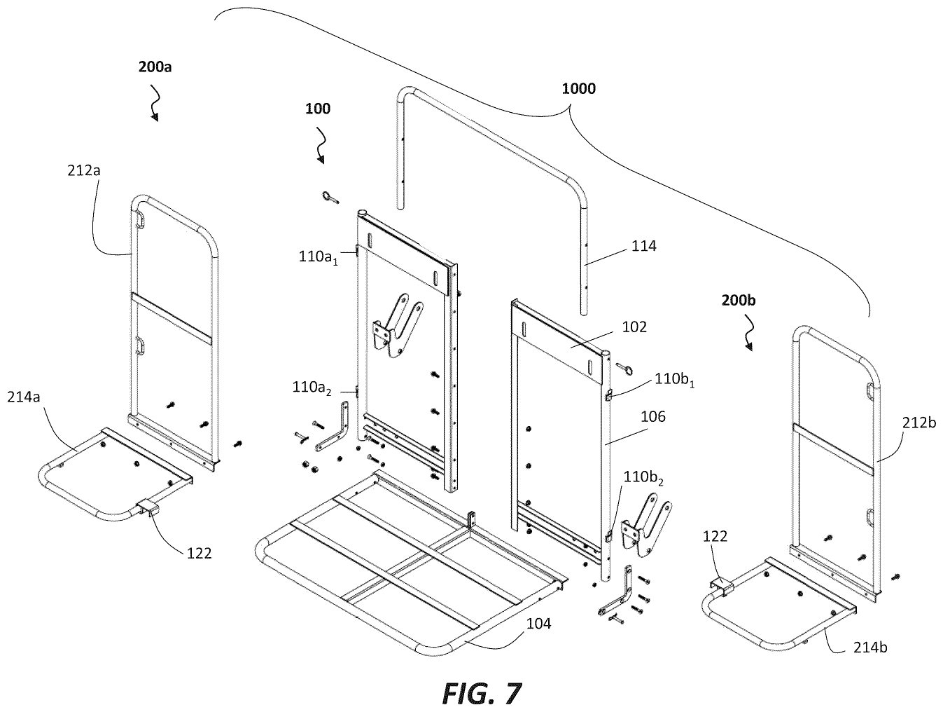

The frame 102 may be sized to accommodate one, two, or more containers (e.g., trash or recycling receptacles or other types of containers). In some embodiments, the base platform 104 may have a length and a width that are each between 20-40 inches. In certain embodiments, the length and the width of the base platform 104 may be equal or approximately equal. The back 106 may have a width that is equal or approximately equal to the width of the base platform 104 (i.e., between 20-40 inches). The back 106 may have a height that is greater than its width. In some embodiments, the height of the back 106 may be between 40-60 inches. However, other dimensions are also contemplated by the present disclosure. In certain embodiments, the back 106 may have an adjustable height. For example, in some such embodiments, upright members of the frame 102 forming the back 106 may be configured to telescope vertically so that a user can adjust the height of the back 106 as desired. In select embodiments, the back 106 may include a U-shaped bar 114 (shown in FIGS. 6 and 7) that can be adjusted up on down in the frame 102 and secured in place using a key with a spring-loaded pin and corresponding keyhole (discussed in detail with respect to FIGS. 11A-11B) or other attachment mechanism.

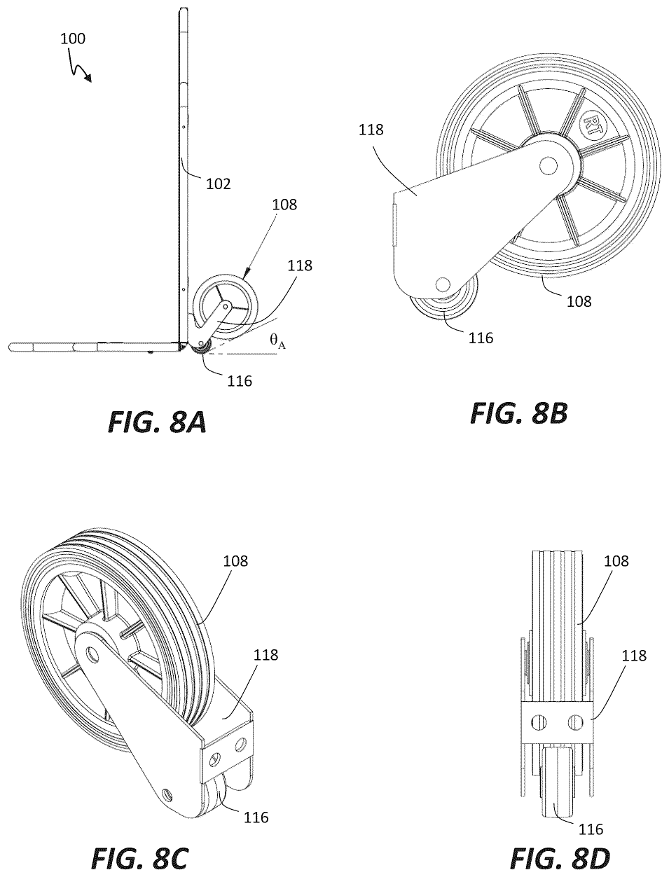

The main unit 100 also includes at least two wheels 108a, 108b fixedly mounted to the frame 102. The at least two wheels 108a, 108b are positioned to engage with the ground (i.e., ground engageable). The at least two wheels 108a, 108b may be mounted to the back 106 (as shown in FIG. 1) or, in other embodiments, may be mounted to the base platform 104. In some embodiments, the main unit 100 may include more than two wheels (e.g., three, four, or more wheels), if desired. In select embodiments, the main unit 100 may also include at least two breaker wheels. An example breaker wheel 116 mounted to a wheel 108 is shown in FIGS. 8A-8D. As shown in FIGS. 8A-8D, an angled bracket 118 may be used to mount both wheel 108 and breaker wheel 116 to the frame 102. Angled bracket 118 may be shaped to position an exterior surface of the breaker wheel 116 at an angle (θ_{A}) with respect to an exterior surface of the wheel 108, as shown in FIG. 8A. In some embodiments, angle θ_{A} may be between 15° and 35°, and in some embodiments between 20° and 30°.

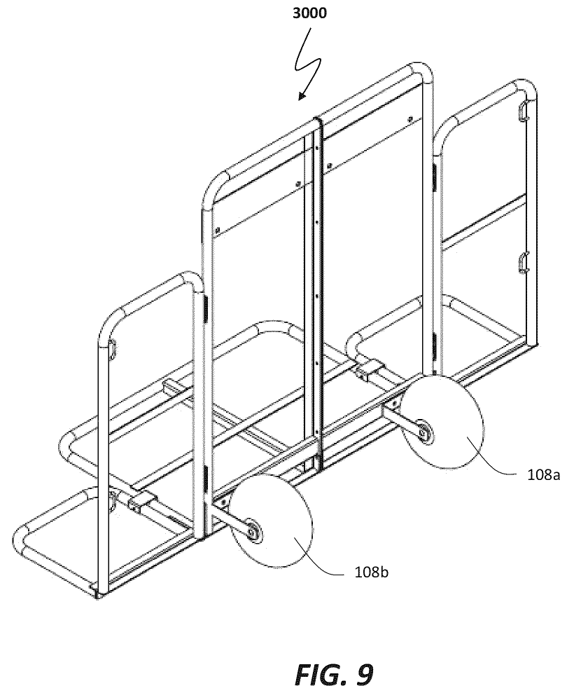

The at least two wheels 108a, 108b may be made from any suitable type of material. For example, in certain embodiments, the at least two wheels 108a, 108b are made of plastic and/or rubber, which presents advantages in terms of durability and handling. Some types of rubber that may be used to construct the wheels 108a, 108b include natural rubber, synthetic rubber, butadiene rubber, styrene-butadiene rubber, neoprene rubber (i.e., chloroprene), silicone rubber, fluorosilicone rubber, and combinations thereof. The at least two wheels 108a, 108b may be solid or air-filled. In select embodiments, such as shown in FIG. 9, the at least two wheels 108a, 108b may be low pressure balloon wheels (such as WHEELEEZ™ beach wheels). In embodiments in which plastic(s) are used to form the at least two wheels 108a, 108b, polypropylene, polyamide, nylon, polyolefins, and/or combinations thereof may be used.

The at least two wheels 108a, 108b may vary in size, and in general may range from about 4 to about 12 inches in diameter. In some embodiments, the at least two wheels 108a, 108b are between 6-10 inches in diameter. In select embodiments, the at least two wheels 108a, 108b are 8 inches in diameter. The at least two wheels 108a, 108b may be mounted to the frame 102 with an L-shaped bracket or another type of attachment mechanism (e.g., an angled bracket 118 as shown in FIGS. 8A-8D). If desired, the wheels 108a, 108b may be foldable to provide for easy storage. Numerous possibilities are possible and contemplated herein.

As shown in the drawings, the first gullwing 200a includes a first upper support 212a affixed to a first lower support 214a. Similarly, the second gulling 200b includes a second upper support 212b affixed to a second lower support 214b. The first upper support 212a is substantially perpendicular to the first lower support 214a and the second upper support 212b is substantially perpendicular to the second lower support 214b. If desired, the first lower support 214a may be secured to the base platform 104 of the main unit 100 with a fastener 122 (illustrated in FIGS. 6-7). Similarly, in these and other embodiments, the second lower support 214b may be secured to the base platform 104 of the main unit 100 with a fastener 122. In some embodiments, fastener 122 may be a C-clip or other type of fastener to provide rigidity.

The first gullwing 200a and the second gullwing 200b may have any desired dimensions. For example, in some embodiments, the first lower support 214a and the second lower support 214b may each have a length and a width of between 10-15 inches. In select embodiments, the length and width of the first lower support 214a and the second lower support 214b are equal or approximately equal. The width of the first upper support 212a and the second upper support 212b may be between 10-15 inches. The height of the first upper support 212a and the second upper support 212b may be between 30-45 inches. However, these dimensions are only illustrative and other dimensions are also contemplated and within the scope of the present disclosure.

Any materials mentioned herein as being suitable for constructing frame 102 may be used to form the first upper support 212a, the first lower support 214a, the second upper support 212b, and/or the second lower support 214b. The first upper support 212a may be affixed to the first lower support 214a using a welding technique, a fastener, or the pieces may be integrally formed. Similarly, the second upper support 212b may be affixed to the second lower support 214b using a welding technique, a fastener, or the pieces may be integrally formed.

The expandable hand truck assembly 1000 includes a fastener assembly to releasably couple the main unit 100 to the first gullwing 200a and/or the second gullwing 200b. The fastener assembly includes components on the main unit 100 that mate to components on the first gullwing 200a and/or the second gullwing 200b. To provide increased versatility and ease of use, mating components may be chosen that are relatively easy to couple and decouple (e.g., without needing tools). As will be appreciated by one of ordinary skill in the art based on the subject disclosure, any suitable type of fastening components may be used to releasably couple the main unit 100 to the first gullwing 200a and/or the second gullwing 200b, including those discussed below in detail.

In some embodiments, the main unit 100 (specifically the back 106) includes one or more first attachment features on a first side and one or more second attachment features on an opposing second side. As shown in FIG. 1, the back 106 includes one or more first attachment features 110a₁, 110a₂ and one or more second attachment features 110b₁, 110b₂. The one or more first attachment features 110a₁, 110a₂ and the one or more second attachment features 110b₁, 110b₂ are each configured to receive a mating feature of a removable gullwing. As shown in FIG. 1, the first gullwing 200a includes attachment members 210a₁, 210a₂, and the second gullwing 200b includes attachment members 210b₁, 210b₂. Although FIG. 1 illustrates two first attachment features 110a₁, 110a₂ and two second attachment features 110b₁, 110b₂, more or less attachment features may be present.

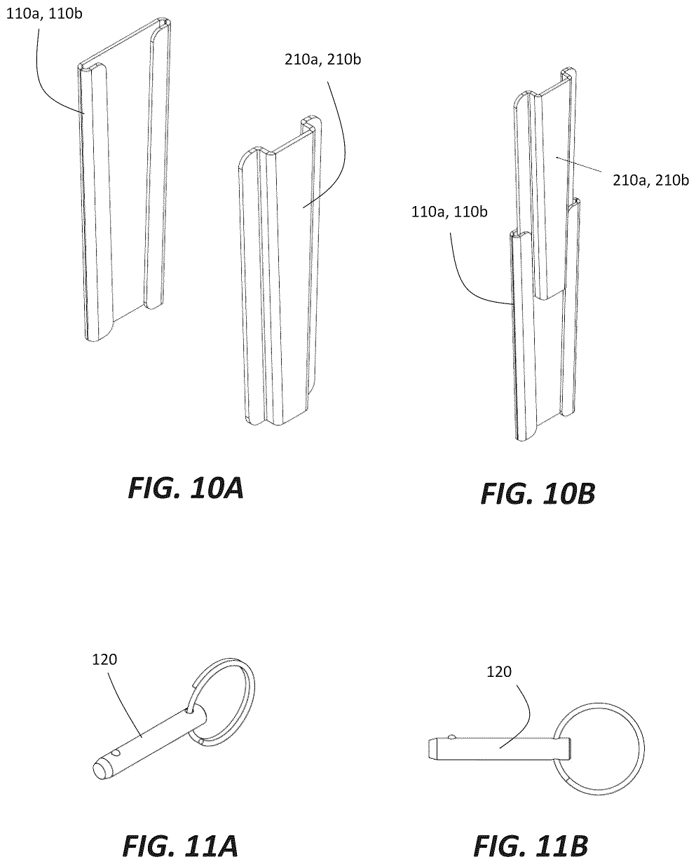

The one or more first attachment features (referred to generally as ‘110a’) and the one or more second attachment features (referred to generally as ‘110b’) can take any suitable form. In some embodiments, for example, the one or more first attachment features 110a and the one or more second attachment features 110b may be one or more slotted channels, each shaped to receive a correspondingly shaped feature (referred to generally as ‘210a, 210b’) fastened to a gullwing. An example V-shaped slotted channel with mating member is illustrated in FIGS. 10A and 10B. FIG. 10A shows a first attachment feature 110a, 110b apart from a mating feature 210a, 210b, and FIG. 10B shows the first attachment feature 110a, 110b of FIG. 10A joining with a mating attachment member 210a, 210b.

In alternative embodiments, the gullwings may be secured to the main unit 100 with one or more spring-loaded keys and corresponding keyholes. FIGS. 11A-11B show an embodiment of a spring-loaded key 120. FIG. 11A shows a perspective view of the spring-loaded key 120, and FIG. 11B shows a side view of the spring-loaded key 120 illustrated in FIG. 11A.

In these and other embodiments, the one or more first attachment features 110a and the one or more second attachment features 110b may be one or more hinges that permit the first removable gullwing 200a and the second removable gullwing 200b to pivot with respect to the frame 102 when attached to the frame 102. In some such embodiments, a first hinge member is attached to a first side of the back 106 and a second hinge member is attached to an opposing second side of the back 106. The first hinge member may be configured to receive a mating hinge feature of the first removable gullwing 200a and the second hinge member may be configured to receive a mating hinge feature of the second removable gullwing 200b. FIGS. 1-3D illustrate an embodiment in which the one or more first attachment features 110a and the one or more second attachment features 110b are hinge members with mating hinge features on the first gullwing 200a and the second gullwing 200b. In some such embodiments, when attached to the main unit 100, the first gullwing 200a and the second gullwing 200b can each transition between a closed position and an open position by pivoting on the back 106 about a vertical axis. In the closed position, the first gullwing 200a and the second gullwing 200b are stored substantially facing the back 106 and in the open position, the first gullwing 200a and the second gullwing 200b each extend out from the back 106. As shown in FIG. 1, the back 106 may have a substantially planar surface facing the base platform 104, and when the first gullwing 200a and the second gullwing 200b are in the open position, the first upper support 212a and the second upper support 212b each extend substantially parallel to the substantially planar surface of the back 106.

In some embodiments, such as the embodiment shown in FIG. 1, the frame 102 of the main unit 100 may be exposed. However, in other embodiments, the frame 102 (i.e., the base platform 104 and/or the back 106) may be covered, for example, with a thin plastic component. In these and other embodiments, the first upper support 212a, the first lower support 214a, the second upper support 212b, and/or the second lower support 214b may also be covered with a thin plastic component, if desired. Covering these components of the expandable hand truck assembly 1000 may help protect loads from wear and tear from the ground or from other objects during transport.

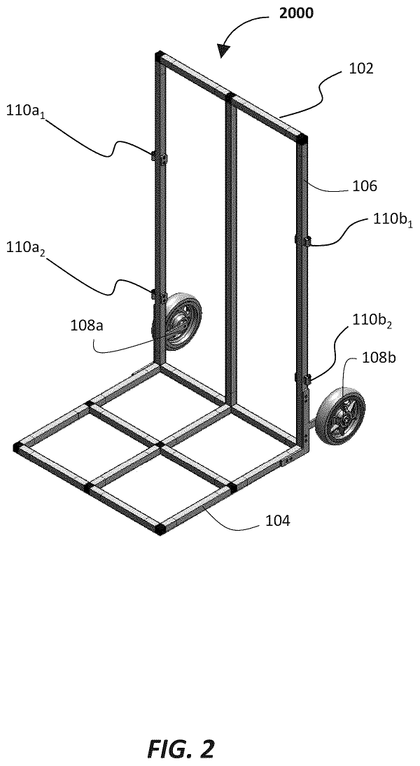

Although FIGS. 1 and 7 illustrate an embodiment of an expandable hand truck assembly 1000 having a main unit 100 and two gullwings 200a, 200b, one skilled in the art will appreciate that, in another aspect, the present disclosure also relates to an expandable hand truck without any gullwings. Such an expandable hand truck 2000 is illustrated in FIG. 2. The expandable hand truck 2000 may include any features discussed herein with respect to the main unit 100 of the hand truck assembly 1000. Similarly, the main unit 100 of the expandable hand truck assembly 1000 may have any features described herein with respect to the expandable hand truck 2000.

In some embodiments, the expandable hand truck 2000 includes a frame 102 having a base platform 104 and a back 106 fixedly attached to the base platform 104. The base platform 104 extends in a substantially horizontal direction and the back 106 extends in a substantially vertical direction when the expandable hand truck 100 is in an upright position. The back 106 may have a substantially planar surface facing the base platform 104. As shown in FIG. 2, the expandable hand truck 2000 also has at least two wheels 108a, 108b fixedly mounted on the frame 102 and positioned to engage with the ground. The at least two wheels 108a, 108b may be mounted on a rear side of the frame 102.

Each side of the back 106 of the expandable hand truck 2000 includes at least one attachment feature. The expandable hand truck 2000 shown in FIG. 2 includes two first attachment features 110a₁, 110a₂ and two second attachment features 110b₁, 110b₂. It should, however, be understood that more or less than two attachment features may be positioned on each side of the back 106. For example, there may be one, two, three, or more first attachment feature(s) and there may be one, two, three, or more second attachment feature(s). The first attachment feature(s) and the second attachment feature(s) are each configured to receive a mating feature of a removable gullwing.

When the expandable hand truck 2000 is in an upright position, the base platform 104 rests on a ground surface. When the expandable hand truck 2000 is rotated onto the at least two wheels 108a, 108b, the base platform 104 lifts off the ground surface. If desired, the frame 102 may also include a footplate (not illustrated) extending from a bottom rear side. The footplate may provide additional leverage for a user to more easily rotate the expandable hand truck 2000 onto its wheels 108a, 108b.

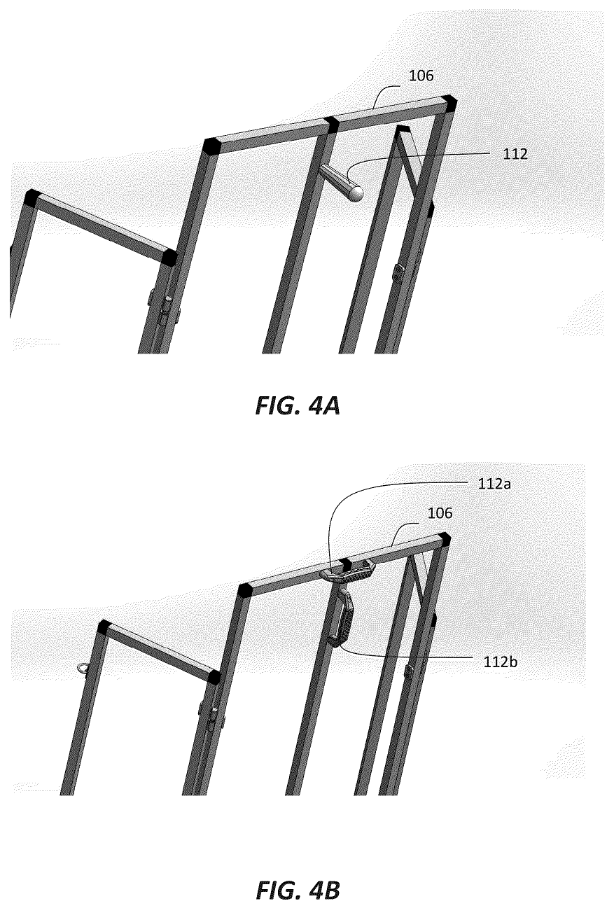

In some embodiments, the expandable hand truck 2000 may also include one or more handles positioned on a top portion of the back 106. FIGS. 4A and 4B illustrate embodiments of handles that may be used in connection with the expandable hand truck 2000. As shown in FIG. 4A, a single handle 112 may extend laterally out from the back 106. If desired, the handle 112 may be contoured for easy hand gripping. In select embodiments, the handle 112 may be adjustable in a vertical and/or a horizontal direction. FIG. 4B illustrates an alternative handle arrangement in which the back 106 includes a first handle 112a positioned horizontally and a second handle 112b positioned vertically.

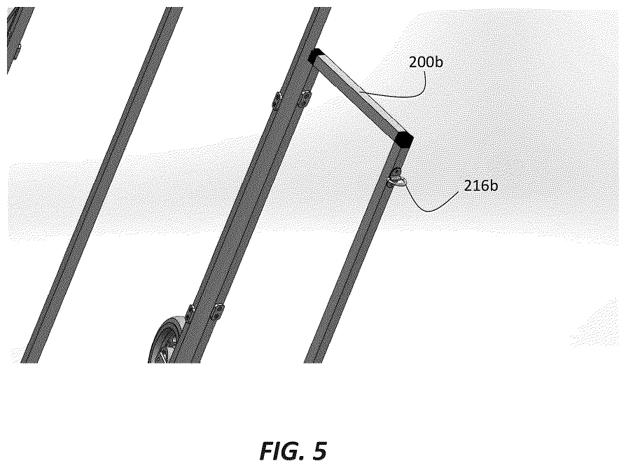

In certain embodiments, the expandable hand truck 2000 also includes a detachable tether (not illustrated) extendable from the first side of the back 106 to the second side of the back 106. If present, the detachable tether may be used to retain one or more containers or other loads on the expandable hand truck 2000. In select embodiments, the tether may be formed of a corded elastic material (e.g., a bungee cord or a shock-cord) or a non-corded elastic material. The tether may be secured to the expandable hand truck 2000 using any suitable fasteners 216. In some embodiments, for example, D-rings may be mounted to opposing sides of the back 106 to secure the tether horizontally (see FIG. 5). In these and other embodiments, D-rings for securing the tether vertically may be positioned on the top and the bottom of the back 106.

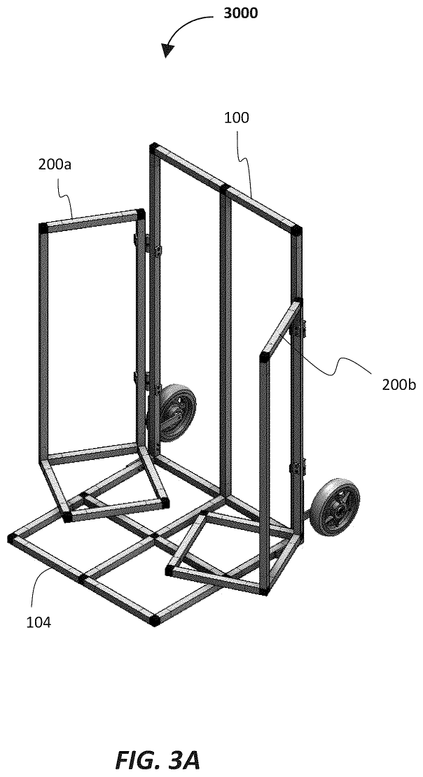

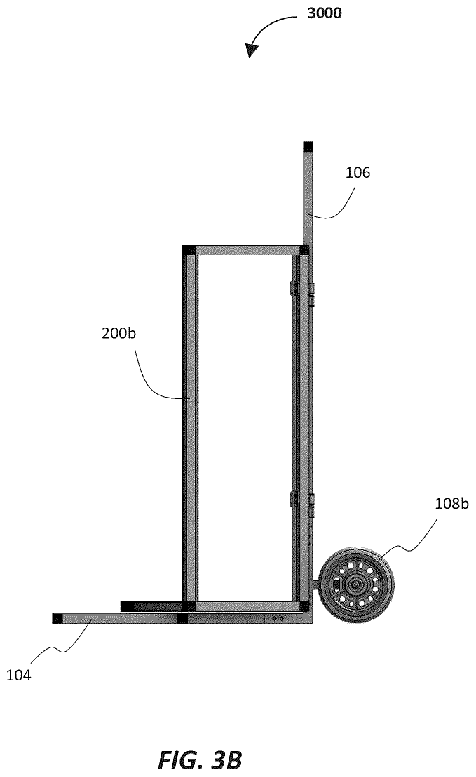

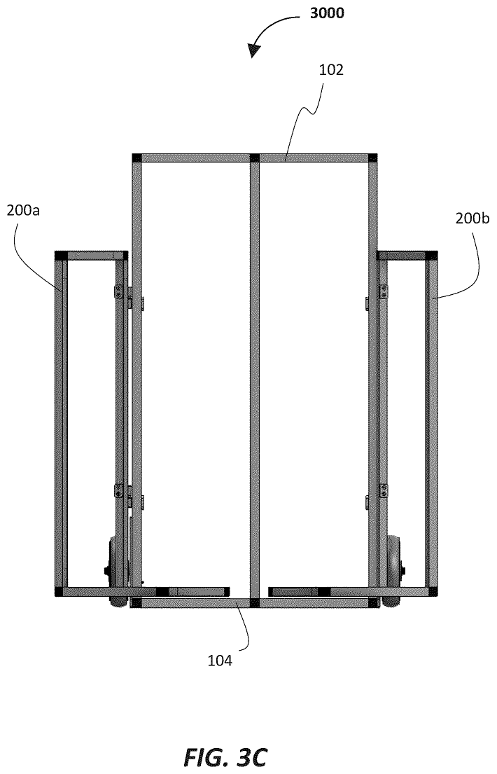

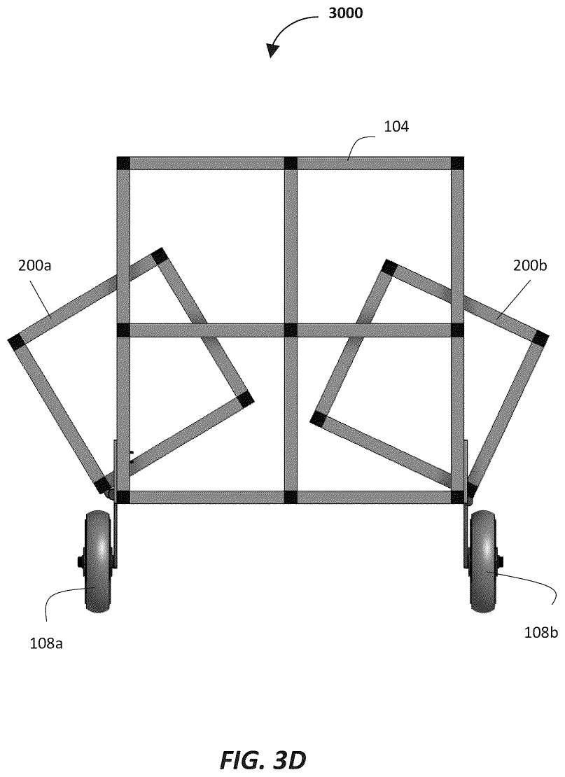

FIG. 3A-3D illustrate an embodiment of an expanded hand truck 3000 in which a first gullwing 200a and a second gullwing 200b are each attached to an expandable hand truck 2000. FIG. 3A shows a perspective view of the expanded hand truck 3000, FIG. 3B illustrates a side view of the expanded hand truck 3000, FIG. 3C illustrates a front view of the expanded hand truck 3000, and FIG. 3D illustrates a bottom view of the expanded hand truck 3000. The components of the expanded hand truck 3000 may include any features of the main unit 100, the expandable hand truck 2000, the first gullwing 200a, and/or the second gullwing 200b as discussed herein.

In some embodiments and as shown in FIGS. 3A-3D, the expanded hand truck 3000 includes a main unit 100 with a frame 102 having a base platform 104 and a back 102 fixedly attached to the base platform 104. The base platform 104 extends in a substantially horizontal direction and the back 106 extends in a substantially vertical direction when the expanded hand truck 3000 is in an upright position. The main unit 100 includes at least two wheels 108a, 108b fixedly mounted on the frame 102 and positioned to engage with the ground. As previously described herein and illustrated in the figures, the main unit 100 includes one or more first attachment features on a first side of the back and one or more second attachment features on an opposing second side of the back. The first gullwing 200a and the second gullwing 200b are each coupled to the main unit 100, as shown in FIGS. 3A-3D. The first gullwing 200a includes a first upper support affixed to a first lower support and a first attachment member mounted on the first upper support and coupled to one of the one or more first attachment features. The second gullwing 200b includes a second upper support affixed to a second lower support and a second attachment member mounted on the second upper support and coupled to one of the one or more second attachment features.

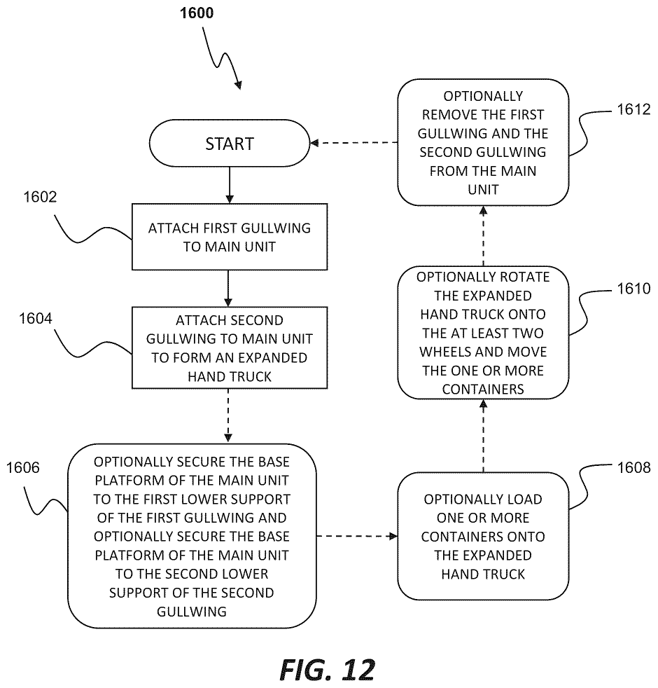

In yet another aspect, the subject disclosure also involves methods of using the expandable hand truck assembly 1000 discussed herein. FIG. 12 illustrates a sample flow diagram of a process 1600 for using the expandable hand truck assembly 1000 that involves attaching a first gullwing 200a to the main unit 100 (Step 1602). In some embodiments, the first gullwing 200a may be attached to the main unit 100 by coupling one or more first attachment features to one or more mating attachment features on the first gullwing 100a. Process 1600 continues with attaching the second gullwing 200b to the main unit 100 to form an expanded hand truck 3000 (Step 1604). The second gullwing 200b may be attached to the main unit 100 by coupling one or more second attachment features to one or more mating attachment features on the second gullwing 200b.

Process 1600 optionally includes securing the base platform 104 of the main unit 100 to the first lower support 214a of the first gullwing 200a and securing the base platform 104 of the main unit 100 to the second lower support 214b of the second gullwing 200b (Step 1606). If desired, the first gullwing 200a and the second gullwing 200b may be secured to the main unit with C-clips 122 or other fasteners. Process 1600 may also optionally include loading one or more containers onto the expanded hand truck 3000 (Step 1608). For example, the one or more containers may be loaded onto the base platform, the first lower support, and/or the second lower support of the expanded hand truck 3000. In some such embodiments, process 1600 may also include rotating the expanded hand truck 3000 onto the at least two wheels and moving the one or more containers (Step 1610). Process 1600 may also include removing the first gullwing 200a and the second gullwing 200b from the main unit 100, if desired (Step 1612).

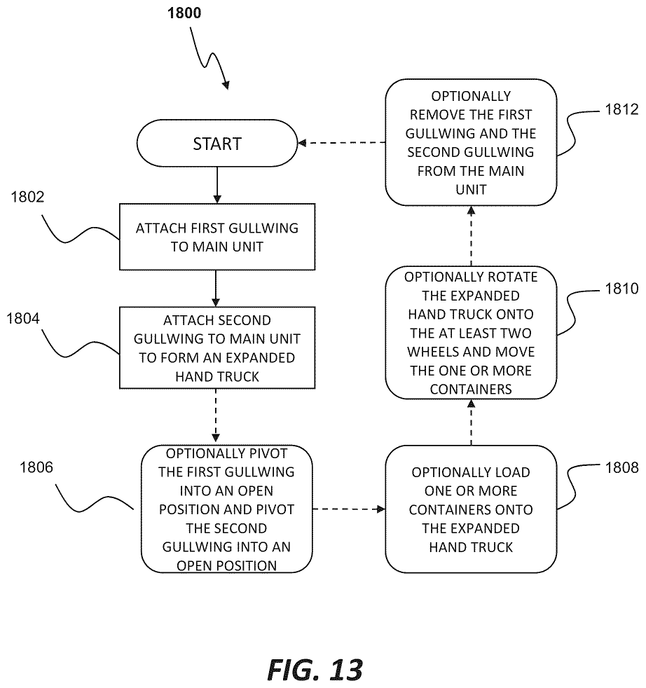

FIG. 13 illustrates a sample flow diagram of a process 1800 for using an expandable hand truck assembly 1000 with pivotable gullwings 200a, 200b. Process 1800 involves attaching a first gullwing 200a to the main unit 100 (Step 1802). In some embodiments, the first gullwing 200a may be attached to the main unit 100 by coupling one or more first attachment features to one or more mating attachment features on the first gullwing 100a. Process 1600 continues with attaching the second gullwing 200b to the main unit 100 to form an expanded hand truck 3000 (Step 1804). The second gullwing 200b may be attached to the main unit 100 by coupling one or more second attachment features to one or more mating attachment features on the second gullwing 200b.

Process 1800 optionally includes rotating the first gullwing 200a into an open position and rotating the second gullwing 200b into an open position (Step 1806). Process 1600 may also optionally include loading one or more containers onto the expanded hand truck 3000 (Step 1808). For example, the one or more containers may be loaded onto the base platform, the first lower support, and/or the second lower support of the expanded hand truck 3000. In some such embodiments, process 1800 may also include rotating the expanded hand truck 3000 onto the at least two wheels and moving the one or more containers (Step 1810). Process 1600 may also include removing the first gullwing 200a and the second gullwing 200b from the main unit 100, if desired (Step 1812).

All orientations and arrangements of the components shown herein are used by way of example only. Further, it will be appreciated by those of ordinary skill in the pertinent art that the functions of several elements may, in alternative embodiments, be carried out by fewer elements or a single element. Similarly, in some embodiments, any functional element may perform fewer, or different, operations than those described with respect to the illustrated embodiment. Also, functional elements shown as distinct for purposes of illustration may be incorporated within other functional elements in a particular embodiment.

While the subject technology has been described with respect to some particular embodiments, those skilled in the art will readily appreciate that various changes and/or modifications can be made to the subject technology. For example, each claim may depend from any or all claims in a multiple dependent manner even though such has not been originally claimed.

What is claimed is:

1. An expandable hand truck:
a frame having a base platform and a back fixedly attached to the base platform, wherein the base platform extends in a substantially horizontal direction and the back extends in a substantially vertical direction when the expandable hand truck is in an upright position;
at least two wheels fixedly mounted on the frame and positioned to be ground engageable;
one or more first attachment features on a first side of the back; and
one or more second attachment features on an opposing second side of the back,
wherein the one or more first attachment features and the one or more second attachment features are each configured to engage a mating feature of a removable gullwing.

2. The expandable hand truck of claim 1, wherein the back has a substantially planar surface facing the base platform.

3. The expandable hand truck of claim 1, wherein when the expandable hand truck is in an upright position, the base platform rests on a ground surface.

4. The expandable hand truck of claim 3, wherein the base platform lifts off the ground surface when the expandable hand truck is rotated onto the at least two wheels.

5. The expandable hand truck of claim 1, wherein the at least two wheels are mounted on a rear side of the frame.

6. The expandable hand truck of claim 1, further comprising a vertically adjustable handle positioned on a top portion of the back.

7. The expandable hand truck of claim 1, further comprising at least two breaker wheels.

8. The expandable hand truck of claim 1, further comprising a footplate extending from a bottom rear side of the frame.

9. The expandable hand truck of claim 1, further comprising a detachable tether extendable from the first side of the back to the second side of the back to retain one or more containers on the expandable hand truck.

10. The expandable hand truck of claim 1, wherein the base platform is pivotably mounted to the back.

11. An expandable hand truck assembly comprising:
a main unit comprising:
a frame having a base platform and a back fixedly attached to the base platform, wherein the base platform extends in a substantially horizontal direction and the back extends in a substantially vertical direction when the main unit is in an upright position;
at least two wheels fixedly mounted on the frame and positioned to be ground engageable;
one or more first attachment features on a first side of the back; and
one or more second attachment features on an opposing second side of the back;
a first gullwing removably attachable to the main unit, the first gullwing comprising:
a first upper support affixed to a first lower support; and
one or more first attachment members mounted on the first upper support and couplable to the one or more first attachment features; and
a second gullwing removably attachable to the main unit, the second gullwing comprising:
a second upper support affixed to a second lower support; and
one or more second attachment members mounted on the second upper support and couplable to the one or more second attachment features.

12. The expandable hand truck assembly of claim 11, wherein the one or more first attachment features and the one or more second attachment features are selected from the group consisting of slotted channels, spring-loaded keys, and hinges.

13. The expandable hand truck assembly of claim 11, further comprising one or more fasteners configured to rigidly secure the first lower support and the second lower support to the base platform of the main unit.

14. The expandable hand truck assembly of claim 11, wherein when attached to the main unit, the first gullwing and the second gullwing are each pivotable to transition between a closed position and an open position.

15. The expandable hand truck assembly of claim 11, wherein the first upper support is substantially perpendicular to the first lower support and the second upper support is substantially perpendicular to the second lower support.

16. The expandable hand truck assembly of claim 11, wherein the first gullwing and the second gullwing are each attached to the main unit to form an expanded hand truck.

17. A method of using the expandable hand truck assembly of claim 11 comprising:
attaching the first gullwing to the main unit by coupling the one or more first attachment features to the one or more first attachment members; and
attaching the second gullwing to the main unit by coupling the one or more second attachment features to the one or more second attachment members to form an expanded hand truck.

18. The method of claim 17, further comprising securing the first lower support of the first gullwing and the second lower support of the second gullwing to the base platform of the main unit.

19. The method of claim 17, further comprising pivoting the first gullwing into an open position and pivoting the second gullwing into an open position.

20. The method of claim 17, further comprising loading one or more containers onto the base platform, the first lower support, and/or the second lower support of the expanded hand truck, rotating the expanded hand truck onto the at least two wheels, and moving the one or more containers.

21. An expanded hand truck comprising:
a main unit comprising:
a frame having a base platform and a back fixedly attached to the base platform, wherein the base platform extends in a substantially horizontal direction and the back extends in a substantially vertical direction when the expanded hand truck is in an upright position;
at least two wheels fixedly mounted on the frame and positioned to be ground engageable;
one or more first attachment features on a first side of the back; and
one or more second attachment features on an opposing second side of the back;
a first gullwing coupled to the main unit, the first gullwing comprising:
a first upper support affixed to a first lower support; and
one or more first attachment members mounted on the first upper support and coupled to the one or more first attachment features; and
a second gullwing coupled to the main unit, the second gullwing comprising:
a second upper support affixed to a second lower support; and
one or more second attachment members mounted on the second upper support and coupled to the one or more second attachment features.
